(19) United States
(12) Patent Application Publication
(10) Pub. No.: US 2024/0209229 A1
(43) Pub. Date: Jun. 27, 2024

(54) WASHABLE CONDUCTIVE INK

(71) Applicant: San Fang Chemical Industry Co., Ltd., Kaohsiung City (TW)

(72) Inventors: CHIH-YI LIN, Kaohsiung City (TW); Kuo-Kuang Cheng, Kaohsiung City (TW); Kao-Lung Yang, Kaohsiung City (TW); I-Ju Wu, Kaohsiung City (TW); Pin-Hsien Sung, Kaohsiung City (TW)

(21) Appl. No.: 18/545,292

(22) Filed: Dec. 19, 2023

(30) Foreign Application Priority Data
Dec. 23, 2022 (TW) 111149781

(51) Int. Cl. C09D 11/52; C09D 11/106

(52) U.S. Cl. CPC C09D 11/52; C09D 11/106

(57) ABSTRACT

A washable conductive ink is provided. The washable conductive ink includes chloroprene rubber resin and conductive particles mixed in the chloroprene rubber resin. A chemical structure of the chloroprene rubber resin includes a linear structure and a nonlinear structure.

### BACKGROUND

### 1. Field of the Disclosure

The present disclosure relates to a washable conductive ink.

### 2. Description of the Related Art

Conductive ink has been applied in various electronic devices because of its conductive property. The conductive ink can be applied on various substrates through various coating methods, such as touch panels, electric heating sheets and display elements. In addition, the conductive ink is more efficient than metal welding with large areas of wires, so that the application field of the conductive ink is more extensive.

However, conventional conductive ink generally does not have washability, so its conductivity will be reduced in a washing environment and may completely disappear after multiple times of washing. Therefore, its application in the washing environment (such as objects to be cleaned) is greatly hindered.

### SUMMARY

In some embodiments, a washable conductive ink includes chloroprene rubber resin and conductive particles mixed in the chloroprene rubber resin. A chemical structure of the chloroprene rubber resin includes a linear structure and a nonlinear structure.

In some embodiments, a washable conductive ink includes chloroprene rubber resin, conductive particles and an adhesive. The conductive particles and the adhesive are mixed in the chloroprene rubber resin.

In some embodiments, a washable conductive ink includes chloroprene rubber resin, conductive particles and a defoaming agent. The conductive particles and the defoaming agent are mixed in the chloroprene rubber resin.

### DETAILED DESCRIPTION

A washable conductive ink in an Example 1 of the present disclosure includes chloroprene rubber resin, conductive particles, a solvent, a stabilizer and a defoaming agent.

The chloroprene rubber resin may also be referred to as “chlorobutadiene rubber resin” or “polychloroprene rubber resin,” and it is synthetic rubber formed by polymerizing 2-chloro-1,3-butadiene (the chemical formula is CH2=CCI—CH═CH2). The chloroprene rubber resin has good chemical stability, stretchability and flexibility. In some embodiments, a content of the chloroprene rubber resin may be 7 wt % to 15 wt % based on the total amount of the conductive ink as 100 wt %.

In some embodiments, a chemical structure of the chloroprene rubber resin may simultaneously include a linear structure and a nonlinear structure. The linear structure may also be referred to as “linear chain structure.” The nonlinear structure may also be referred to as “branched chain structure” or “network structure.” In some embodiments, a content of the linear structure may be greater than a content of the nonlinear structure, thus improving the stretchability and the elasticity of the chloroprene rubber resin. In some embodiments, the content of the linear structure may be greater than or equal to 70 wt % and smaller than or equal to 90 wt %. In some embodiments, a ratio of the linear structure to the nonlinear structure may be (2.34:1) to (9:1).

The conductive particles are mixed in the chloroprene rubber resin. The conductive particles may have one or more shapes, such as particles, lines, sheets, tubes or combination thereof. A material of the conductive particles may be selected from the group consisting of gold, silver, copper, carbon nanotubes, carbon nanosheets, graphite, carbon black, graphene and mixtures thereof. In some embodiments, a content of the conductive particles may be 3 to 7 times the content of the chloroprene rubber resin. When the content of the conductive particles is greater than 7 times the content of the chloroprene rubber resin or when the content of the conductive particles is less than 3 times the content of the chloroprene rubber resin, a coating formed after coating and drying on a substrate may not provide enough washability and conductivity after washing. In some embodiments, the content of the conductive particles may be 4 to 6.5 times the content of the chloroprene rubber resin. In some embodiments, the content of the conductive particles may be 40 wt % to 60 wt % based on the total amount of the conductive ink as 100 wt %.

The solvent is mixed with the chloroprene rubber resin and the conductive particles. The solvent may be selected from the group consisting of an aqueous medium solvent, an organic medium solvent and a mixture thereof. In some embodiments, a content of the solvent may be 10 wt % to 40 wt % based on the total amount of the conductive ink as 100 wt %. In some embodiments, the organic medium solvent may be selected from the group consisting of an alcohol-based solvent, a diol-based solvent, a ketone-based solvent, an ester-based solvent, an ether-based solvent, an aliphatic or alicyclic hydrocarbon-based solvent, an aromatic hydrocarbon-based solvent, a cyanogen-containing hydrocarbon solvent and a mixture thereof.

The stabilizer is mixed with the solvent, the chloroprene rubber resin and the conductive particles. The stabilizer is used to improve the stability of the conductive ink. The stabilizer may be selected from the group consisting of tris(nonylphenol)phosphite, epoxidized soybean oil and a mixture thereof. In some embodiments, a content of the stabilizer may be 0.1 wt % to 5 wt %, 0.3 wt % to 4 wt % or 0.5 wt % to 2 wt % based on the total amount of the conductive ink as 100 wt %.

The defoaming agent is mixed with the solvent, the stabilizer, the chloroprene rubber resin and the conductive particles. The defoaming agent is used to reduce the generation of bubbles. In some embodiments, the defoaming agent may be a non-organosilicon defoaming agent, that is, the defoaming agent is free of containing organosilicon. In some embodiments, the defoaming agent may be a polymer defoaming agent. In some embodiments, a content of the defoaming agent may be 0.1 wt % to 1 wt % based on the total amount of the conductive ink as 100 wt %.

In some embodiments, the conductive ink may be coated on the substrate by screen printing, ink-jet printing, intaglio printing, letterpress printing, lithographic printing or other suitable printing methods. In some embodiments, the substrate may be selected from the group consisting of polyethylene terephthalate (PET), polyimide (PI), polyetherimide (PEI) and thermoplastic polyurethane (TPU). In some embodiments, the substrate may be a textile.

After coating, the conductive ink may be dried by removing the solvent, so as to obtain a washable and stretchable conductive coating on the substrate. The drying step may be carried out without causing cracking of the chloroprene rubber resin. In some embodiments, the drying temperature may be 80° C. to 160° C. or 100° C. to 140° C. The drying time may be 10 min to 50 min. The coating pressure may be 0.5 kgf to 10 kgf or 4 kgf to 7 kgf.

A washable conductive ink in an Example 2 of the present disclosure is similar to the washable conductive ink in the Example 1, except that the washable conductive ink in the Example 2 further includes a dispersant. The dispersant is mixed with the solvent, the stabilizer, the defoaming agent, the chloroprene rubber resin and the conductive particles. The dispersant is used to help disperse the conductive particles in a solution. In some embodiments, the dispersant may be a non-aqueous dispersant, such as a 100% active polymer dispersant. In some embodiments, a content of the dispersant may be 0.5 wt % to 2 wt % based on the total amount of the conductive ink as 100 wt %.

A washable conductive ink in an Example 3 of the present disclosure is similar to the washable conductive ink in the Example 2, except that the washable conductive ink in the Example 3 further includes an adhesive. The adhesive is mixed with the solvent, the stabilizer, the defoaming agent, the dispersant, the chloroprene rubber resin and the conductive particles. The adhesive is used to improve the adhesiveness of the conductive ink. In some embodiments, the adhesive may be a reactive adhesive, such as a methacrylate modified acidic adhesive. In some embodiments, a content of the adhesive may be 0.1 wt % to 2 wt % based on the total amount of the conductive ink as 100 wt %.

The present disclosure is illustrated in detail with the following embodiments, but it does not mean that the present disclosure is only limited to the content disclosed by these embodiments.

### Comparative Embodiment

A conductive ink included 6 wt % of chloroprene rubber resin, 20 wt % of 2-ethylhexyl acrylate, 3 wt % of epoxidized soybean oil, 1 wt % of tris(nonylphenol)phosphite and 45 wt % of silver powder according to a formula. The chloroprene rubber resin was dissolved in 2-ethylhexyl acrylate at room temperature, and the mixing time was 4-12 h according to different quantities. Then, the chloroprene rubber resin solution was mixed with the epoxidized soybean oil, the tris(nonylphenol)phosphite and the silver powder using a stirring device to obtain a silver paste ink.

A surface of a TPU substrate was coated with the silver paste ink by screen printing, and then the TPU substrate was dried in an environment at 100° C. to 150° C. for 10 min to 30 min to form a long strip-shaped conductive coating of 0.5 cm*10 cm on the substrate. Then, the resistance values of the conductive coating before and after washing were detected and recorded in the following Table 1. The washing conditions were ASTM AATCC135.

### Embodiment 1

A conductive ink included 9 wt % of chloroprene rubber resin, 25 wt % of 2-ethylhexyl acrylate, 3 wt % of epoxidized soybean oil, 0.1 wt % of non-organosilicon defoaming agent (BYK-052N), 1 wt % of tris(nonylphenol)phosphite and 45 wt % of silver powder according to a formula. The chloroprene rubber resin was dissolved in 2-ethylhexyl acrylate at room temperature, and the mixing time was 4-12 h according to different quantities. Then, the chloroprene rubber resin solution was mixed with the epoxidized soybean oil, the non-organosilicon defoaming agent (BYK-052N), the tris(nonylphenol)phosphite and the silver powder using a stirring device to obtain a silver paste ink.

A surface of a TPU substrate was coated with the silver paste ink by screen printing, and then the TPU substrate was dried in an environment at 100° C. to 150° C. for 10 min to 30 min to form a long strip-shaped conductive coating of 0.5 cm*10 cm on the substrate. Then, the resistance values of the conductive coating before and after washing were detected and recorded in the following Table 1. The washing conditions were ASTM AATCC135.

### Embodiment 2

A conductive ink included 8 wt % of chloroprene rubber resin, 22 wt % of 2-ethylhexyl acrylate, 0.6 wt % of a non-aqueous dispersant (Solsperse™36000), 0.1 wt % of a non-organosilicon defoaming agent (BYK-052N), 0.8 wt % of tris(nonylphenol)phosphite and 45 wt % of silver powder according to a formula. The chloroprene rubber resin was dissolved in 2-ethylhexyl acrylate at room temperature, and the mixing time was 4-12 h according to different quantities. Then, the chloroprene rubber resin solution was mixed with the non-aqueous dispersant (Solsperse™36000), the non-organosilicon defoaming agent (BYK-052N), the tris(nonylphenol)phosphite and the silver powder using a stirring device to obtain a silver paste ink.

A surface of a TPU substrate was coated with the silver paste ink by screen printing, and then the TPU substrate was dried in an environment at 100° C. to 150° C. for 10 min to 30 min to form a long strip-shaped conductive coating of 0.5 cm*10 cm on the substrate. Then, the resistance values of the conductive coating before and after washing were detected and recorded in the following Table 1. The washing conditions were ASTM AATCC135.

### Embodiment 3

A conductive ink included 11 wt % of chloroprene rubber resin, 30 wt % of 2-ethylhexyl acrylate, 0.6 wt % of a non-aqueous dispersant (Solsperse™36000), 0.5 wt % of a methacrylate modified acidic adhesive (EBECRYL® 168), 0.1 wt % of a non-organosilicon defoaming agent (BYK-052N), 0.8 wt % of tris(nonylphenol)phosphite and 50 wt % of silver powder according to a formula. The chloroprene rubber resin was dissolved in 2-ethylhexyl acrylate at room temperature, and the mixing time was 4-12 h according to different quantities. Then, the chloroprene rubber resin solution was mixed with the non-aqueous dispersant (Solsperse™36000), the methacrylate modified acidic adhesive (EBECRYL® 168), the non-organosilicon defoaming agent (BYK-052N), the tris(nonylphenol)phosphite and the silver powder using a stirring device to obtain a silver paste ink.

A surface of a TPU substrate was coated with the silver paste ink by screen printing, and then the TPU substrate was dried in an environment at 100° C. to 150° C. for 10 min to 30 min to form a long strip-shaped conductive coating of 0.5 cm*10 cm on the substrate. Then, the resistance values of the conductive coating before and after washing were detected and recorded in the following Table 1. The washing conditions were ASTM AATCC135.

The resistance values of the conductive coatings before and after washing in the Comparative Embodiment and the Embodiments 1-3 are sorted as shown in Table 1. According to the result in Table 1, in the Embodiments 1-3, the resistance values of the conductive coatings after washing 30 times may be controlled below 50 Q, indicating that the conductive ink in the Embodiments 1-3 has good washability.

TABLE 1

| | Not | Washing frequency | | | | |
|---|---|---|---|---|---|---|
| | washed | 5 times | 10 times | 15 times | 20 times | 30 times |
| | (Ω) | (Ω) | (Ω) | (Ω) | (Ω) | (Ω) |
| Comparative | 0.2 | 21 | 74 | 92 | 113 | 255 |
| Embodiment | | | | | | |
| Embodiment 1 | 0.1 | 5.8 | 6.7 | 9.5 | 18 | 35 |
| Embodiment 2 | 0.1 | 3.8 | 4.1 | 6.6 | 11 | 17 |
| Embodiment 3 | 0.1 | 0.2 | 0.2 | 0.7 | 1.1 | 1.5 |

While several embodiments of the present disclosure have been illustrated and described, various modifications and improvements can be made by those skilled in the art. The embodiments of the present disclosure are therefore described in an illustrative but not in a restrictive sense. It is intended that the present disclosure should not be limited to the particular forms as illustrated and that all modifications which maintain the spirit and scope of the present disclosure are within the scope defined in the appended claims.

What is claimed is:

1. A washable conductive ink comprises chloroprene rubber resin and conductive particles mixed in the chloroprene rubber resin, wherein a chemical structure of the chloroprene rubber resin includes a linear structure and a nonlinear structure.

2. The washable conductive ink of claim 1, wherein a content of the chloroprene rubber resin is 7 wt % to 15 wt %, and a content of the conductive particles is 3 to 7 times the content of the chloroprene rubber resin.

3. The washable conductive ink of claim 1, wherein a content of the linear structure is greater than a content of the nonlinear structure.

4. The washable conductive ink of claim 1, further comprising:
a solvent: 10 wt % to 40 wt %;
a dispersant: 0.5 wt % to 2 wt %;
an adhesive: 0.1 wt % to 2 wt %; and
a defoaming agent: 0.1 wt % to 1 wt %.

5. The washable conductive ink of claim 4, wherein the solvent is selected from the group consisting of an alcohol-based solvent, a diol-based solvent, a ketone-based solvent, an ester-based solvent, an ether-based solvent, an aliphatic or alicyclic hydrocarbon-based solvent, an aromatic hydrocarbon-based solvent, a cyanogen-containing hydrocarbon solvent and a mixture thereof, the dispersant is a non-aqueous dispersant, the adhesive is a reactive adhesive, and the defoaming agent is a non-organosilicon defoaming agent.

6. The washable conductive ink of claim 1, wherein a material of the conductive particles is selected from the group consisting of gold, silver, copper, carbon nanotubes, carbon nanosheets, graphite, carbon black, graphene and mixtures thereof.

7. A washable conductive ink comprises chloroprene rubber resin, conductive particles and an adhesive, wherein the conductive particles and the adhesive are mixed in the chloroprene rubber resin.

8. The washable conductive ink of claim 7, wherein a content of the chloroprene rubber resin is 7 wt % to 15 wt %, a content of the conductive particles is 3 to 7 times the content of the chloroprene rubber resin, and a content of the adhesive is 0.1 wt % to 2 wt %.

9. A washable conductive ink comprises chloroprene rubber resin, conductive particles and a defoaming agent, wherein the conductive particles and the defoaming agent are mixed in the chloroprene rubber resin.

10. The washable conductive ink of claim 9, wherein a content of the chloroprene rubber resin is 7 wt % to 15 wt %, a content of the conductive particles is 3 to 7 times the content of the chloroprene rubber resin, and a content of the defoaming agent is 0.1 wt % to 1 wt %.
